(19) United States
(12) Patent Application Publication
(10) Pub. No.: US 2011/0265506 A1
(43) Pub. Date: Nov. 3, 2011

(54) High Ratio Mobile Electric HVAC System

(76) Inventor: Gerald Allen Alston, Oakland, CA (US)

(21) Appl. No.: 12/772,193

(22) Filed: May 1, 2010

(51) Int. Cl. F25B 49/00; F25B 41/00; B60H 3/00; F25B 1/10; F25B 49/02

(52) U.S. Cl. 62/228.3; 62/510; 62/228.5; 62/230; 165/43; 62/513

(57) ABSTRACT

An energy efficient and highly versatile electrically-powered air conditioning and heating system for mobile vehicles. Multiple variable-speed compressors operate in series and parallel modes giving an exceptionally wide range of operating capacity making the system suitable for combined on-highway and no-idle use in trucks. In series mode, the single-stage compressors function like a two-stage compressors for increased energy efficiency. A unique power control and storage system has multi-voltage input and output capability without the use of DC-DC or DC-AC converters. A battery management system is incorporated which is compatible with all advanced battery technologies and offers cell-level charge and discharge control.

### FEDERALLY SPONSORED RESEARCH

None

### SEQUENCE LISTING OR PROGRAM

None

### BACKGROUND

1. Field

This application relates to a predominately electrically powered HVAC system for mobile vehicles, and specifically to such a system using two separately controlled compressors.

2. Prior Art

Being alert and well-rested is important for the safety of truck drivers and others who share the road with them. Regulations in the United States and elsewhere limit the number of hours that a driver can be behind the wheel without an extended rest break. To comply with these regulations and avoid making side trips to costly and out-of-the-way motels, it is common practice for drivers to sleep in their trucks. Heavy duty trucks designed specifically for long haul operation, commonly known as Class 8 trucks in the U.S., have sleeping accommodations built into the driver's cab for this purpose.

To ensure that the driver gets a restful sleep, it is often necessary to cool or heat the sleeper cab during rest periods, just as it is during on-highway operation. Until recently, this was accomplished by simply leaving the engine idling and using the engine-powered air conditioning and heating system. While this accomplishes the goal of maintaining a comfortable cab temperature, it does so at a substantial fuel cost to the truck operator and generates a great deal of air pollution. For this reason, many developed countries have recently banned the practice of extended engine idling. Without the ability to use the engine-driven heating and cooling system in rest stops, a new market has developed for what is known in the industry as no-idle HVAC systems. At present, manufacturers install these no-idle HVAC systems in addition to the standard engine-driven HVAC systems. Buying, installing and maintaining two HVAC systems on every truck adds an exceptional financial burden but the prior art does not provide a commercially acceptable, single system, alternative.

Because the regulations prevent running the vehicle propulsion engine when the truck is not on the road, it is necessary for these no-idle system to use an alternate source of power from the engine-drive alternator. Initially, the new systems were powered by a small, non-propulsion internal combustion (IC) engine which drove the air conditioning compressor either directly by belt, or indirectly through an electric generator. Because the IC engine produced a significant amount of waste heat, it could also provide heating in cold climates either directly through a thermal transfer loop, or indirectly though resistance heating.

In the past few years a number of no-idle air conditioning systems have been introduced that operate from electric energy stored in batteries. The batteries are then recharged by the vehicle alternator charging system once the vehicle returns to on-highway operation. Most of these systems can also operate directly from the utility grid, known in the industry as “shore power”, at times when such a connection is available. These electrically powered systems are highly desirable and generally preferred over other types because they completely eliminate the need to run any type of engine during the sleep period.

The systems of the prior art are all powered by batteries operating at the same voltage as the vehicle's main electrical system—typically 12 vdc. These batteries are recharged from the same engine-drive alternator that supplies the rest of the rest of the electrical load. This reliance on a low-voltage power source becomes a serious physical and financial limitation when trying to increase the cooling capacity of these systems to the degree that would be required if they were to replace the engine-driven systems for on-highway use.

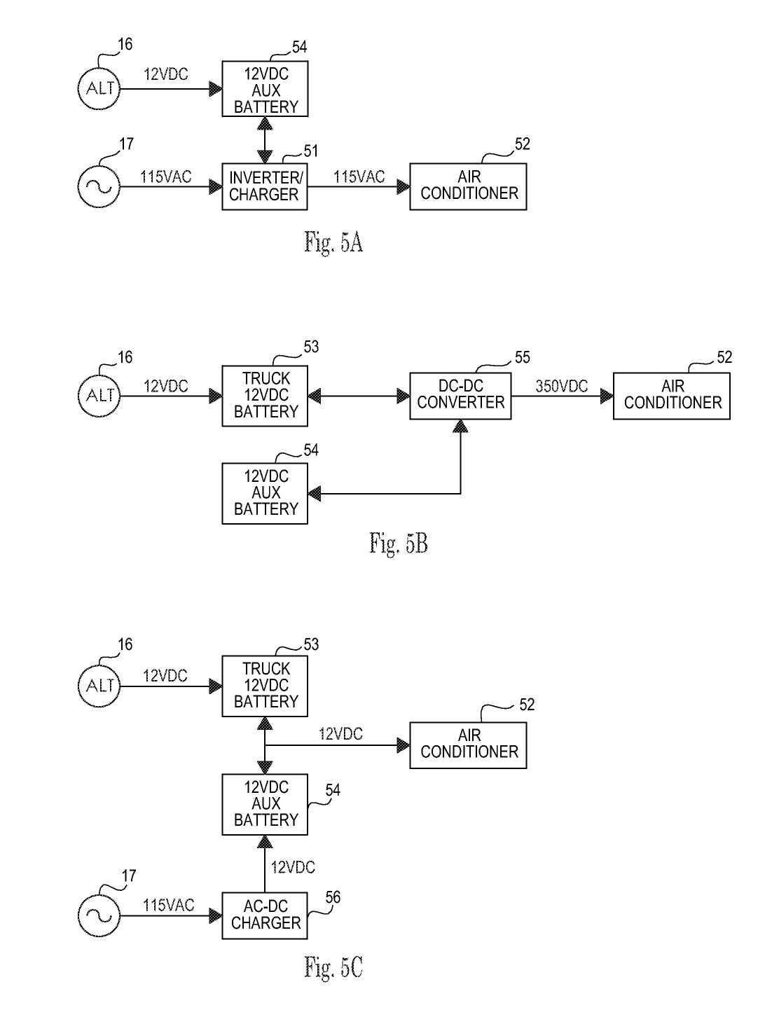

As stated, all of the prior art generates and stores motive electric power at low voltage. However, three different systems are used to regulate, and in some cases transform, that low voltage power for use by the air conditioning systems. In the first type of system, the compressor requires high voltage AC input power. To supply this type of power, the low voltage DC power from the vehicle power system source 16 enters 12 vdc aux. battery 54 which is electrically connected to a DC-AC inverter/charger 51. The 12 vdc power is converted to 115 vac which is the input power required by the system. When these systems are connected to the utility grid, they can be run directly from the supplied power. This type of system typically uses a single-speed compressor. It operates at relatively high efficiency from utility power but less efficiently from DC power due to the single-speed operation and the power conversion losses associated with inverting low-voltage DC power to high voltage AC power. A block diagram of an input power system typical of this type of system is shown in FIG. 5A. Examples of this type of system include the No-Idle Electric system by Dometic Corporation and the Electric APU from Idle-Free Systems, Inc.

In a second type of system, the compressor operates from high-voltage DC power. In these systems, vehicle power system source 16 is connected directly to truck 12 vdc battery 53. Low voltage power may flow bidirectionally to a second source of power, 12 vdc aux. battery 54. Low voltage power from one or both of these two sources is conveyed to a DC-DC converter 55 which boosts voltage to approximately 350 vdc. Shore power is accommodated by using a conventional AC-DC battery charger 56 to supply low-voltage DC to the input side of the system. These systems use a variable-speed compressor which affords them better operating efficiency but requires complex control electronics. By operating the compressor at high voltage, the cost and size of the control system can be reduced due to the lower operating current. However, these advantages are largely offset by the cost, complexity and inefficiency associated with converting all system power from a low-voltage DC source. A block diagram of an input power system typical of this type of system is shown in FIG. 5B. An example of this second type of system is the ClimaCab system manufactured by Glacier Bay, Inc.

A third type of system uses a compressor which is powered from low-voltage DC power. As with the other systems, low voltage DC power is produced by vehicle power system source 16 and stored in a first power source truck 12 vdc battery 53 and a second power source 12 vdc aux battery 54. The compressor, which is typically driven by a variable-speed permanent magnet motor, operates directly from the low voltage DC. For shore power operation, AC power from the utility grid 17 is rectified and bucked to a lower voltage through an AC-DC charger 56. This type of system avoids the DC-DC conversion costs and losses associated with the second type of system described above. However, these advantages are offset by the high running current of the power electronics and wiring which are required to power the low-voltage compressor. A block diagram of an input power system typical of this type of system is shown in FIG. 5C. Examples of this third type of system include the Nite system manufactured by Bergstrom, Inc., the ParkSmart system sold by Freightliner and the SW Arctic systems manufactured by Indel-b.

The mobile electric HVAC systems of the prior art are intended to provide cooling when the truck is in a rest stop, generally away from a utility grid connection and with the engine turned off. As such, they are optimized to provide as much cooling power as possible using only motive power supplied from one or more banks of batteries. Once the rest period is over and the truck returns to on-highway operations, the truck alternator replaces the energy which the system has used during the engine-off period. Because the systems operate from stored energy, it naturally follows that their operating time and cooling capacity is limited by the amount of energy stored, the rate at which the energy is consumed and by the rate at which the stored energy can be replaced. In the prior art, these three factors limit maximum capacity and run time of these systems to a level so low that they are unsatisfactory for on-highway HVAC use.

While it is theoretically possible to increase the size of the battery bank to allow the systems to operate for a longer period of time, in practice, this has serious limitations. Carrying too large a battery bank reduces the amount of profit-generating freight that a truck can carry. This, combined with the cost of buying and maintaining a large battery bank, makes large batteries highly undesirable.

The fact that the prior art is designed to operate from a low-voltage DC power source is a further limitation on the maximum cooling power that can be cost-effectively obtained from these systems. Present day truck alternators, typically rated at 130 amps, are strained just to provide sufficient power to replace the power that was consumed in sleeper cab cooling. Adding on-highway air conditioning capability would mean drawing even more power from the alternator.

The power required to recharge a large battery bank combined with the power required to provide the 26,000+ btu/hr typically needed for on-highway air conditioning could easily exceed 5 kW. At 12 v, this means the alternator would need to reliably supply over 400 amps. Making matters still worse is the fact that truck alternators typically put out only 30% of their full rated power when the truck is operating at slow speeds in heavy traffic. Considering this, if 5 kW of input power is required to power the cooling system and to recharge the batteries, a truck operating in heavy traffic at slow speeds would need an alternator with a capacity rated at over 1,330 amps-10× the rating of the alternators commonly used today. Even if such alternators were available, such high current is highly undesirable since generating, controlling and wiring is heavier and more expensive for low-voltage/high-current than it is for higher voltage and lower current.

When the system design does not permit the use of higher input voltage, one way to reduce the amount of current required of the alternator is to reduce the amount of power the system uses when it is running. In U.S. Pat. No. 6,889,762, Zeigler et al. attempts to reduce the size of the battery bank by using an Intelligent Power Generation Management system. This system modulates the speed of the compressor when the propulsion engine is not running and operates the compressor at a minimum speed to extend the duration of operation. Less power is used but less cooling is produced. Therefore, this method is not helpful in a system intended to provide both on-highway and no-idle functionality.

Cooling systems whose capacity closely matches that of the load, are more energy efficient. Many battery-powered no-idle systems take advantage of this fact and increase their efficiency by varying the speed of the compressor so that the system produces the exact amount of cooling required. If, for some reason, the system cannot vary the compressor speed over a sufficiently wide range, the cooling capacity becomes disproportionate to the load and an excessive amount of power is consumed. As will be described below, this becomes yet another serious deficiency in the prior art when the systems are scaled up to higher cooling capacities.

My own U.S. Patent Application 2009/0179080 seeks to reduce the amount of power consumed by intelligently managing the operation of a variable-speed compressor, heating components and other power consuming parts of a vehicle HVAC system. This approach relies on the ability to modulate the speed of the compressor over the full range from maximum to minimum capacity to maximize efficiency and minimize the amount of energy it consumes. The method is highly effective for reducing power consumption. However, steplessly controlling the compressor from minimum to maximum speed becomes more difficult as the cooling capacity of the system increases. This “turn-down ratio” as it is called, might typically be 6:1 in a no-idle system but would have to be 26:1 to provide the same performance in a system that operated in both no-idle and on-highway conditions.

Most no-idle air conditioning systems produce a maximum of approximately 6,000 btu/hr. In such systems it is desirable to be able to modulate this to as low as 1,000 btu/hr. A turn-down ratio of 6:1 (for example, 6,000 btu/hr to 1,000 btu/hr) is the highest that is achieved in the prior art systems and is generally the limit of readily available mass-market compressors. For these systems to be able to function as they are designed in a no-idle condition, and still meet the cooling capacity requirement for on-highway operation, they would have to be able to provide 26,000 btu/hr while still being able to be turned down to 1,000 btu/hr—a 26:1 ratio. The only alternative is to cycle the systems on/off—something which creates unstable air temperatures and consumes more energy.

In a system using only one compressor, there are two main factors which limit it to a 6:1 turn-down ratio. The first is compressor lubrication. The small air conditioning compressors used in these no-idle systems rely on centrifugal force to distribute oil within the compressor. As the compressor slows down, the oil distribution suffers. If the compressor runs too slow, insufficient oil is distributed and the compressor is destroyed due to lack of lubrication.

The second limiting factor is the fact that the present day mass market air conditioning compressors rely on the momentum of the rotating motor/compressor mass to complete a full 360 degree rotation through the compression stroke. As the compressor slows down, there is less momentum energy available to complete the rotation. A compressor built to have a higher turn-down ratio would have to make up for this reduced momentum energy by using a motor and motor control electronics (which are a necessary part of any variable-speed motor) capable of providing more driving force to the compressor. This increased capacity cost money and increases size and weight. As a result, increasing the turn-down ratio of the compressor would also make it bigger, heavier and more expensive.

The invention which is the subject of this application uniquely addresses the problem of insufficient turn-down ratio by flexibly combining multiple compressors in parallel and series configurations within a single refrigerating circuit. Only one other system is known in the prior art that uses two electric compressors—the SW Arctic 2000, made by the Indel-B company, a division of the Berloni Group in Italy. In this system, two small compressors are connected in fixed parallel operation to replace single larger compressor. This approach provides no increase in the maximum turn-down ratio and addresses none of the deficiencies described in other prior art. The SW Arctic 2000 has a maximum capacity of 6,150 btu/hr and a turn-down ratio of approximately 3:1.

For all the reasons presented above, it is clear that the mobile electric conditioning systems of the prior art suffer serious limitations which prevent them from fulfilling the need for a single, commercially viable electrically-powered HVAC system capable of providing energy efficient no-idle operation from battery power during rest periods and also, providing the much higher cooling power needed for on-highway use. These limitations include;
(a) An inability to provide full variable-speed control over the entire range of the required minimum to maximum cooling capacity. To fulfill this function, a single system would need to be adjustable over a 26:1 compressor speed range. The prior art is limited to a 6:1 speed range or less. A system operating with this limitation will consume more power thereby requiring extra energy storage batteries to be carried and recharged. More batteries, means the truck can carry less paying cargo.
(b) Excessively high current draw due to on-highway input power which is limited to the voltage of the vehicle's main electrical system. The higher the capacity of the system, the higher the current draw. High current electrical components are larger, more expensive and often less commercially available than higher voltage, lower-current parts.
(c) A single on-highway continuous input power source which must be shared with all other electrical power consumption on the vehicle. This single point of failure potentially allows a fault in the HVAC system to cause the vehicle to become inoperable.
(d) The power loss and component cost and weight associated with the need to convert power through DC-DC converters and DC-AC invertors.

### SUMMARY

In accordance with one embodiment, an electrically powered mobile HVAC system which efficiently and in one system, fulfills the requirements of both maximum on-highway and minimum no-idle operating conditions.

### DRAWINGS

### Figures

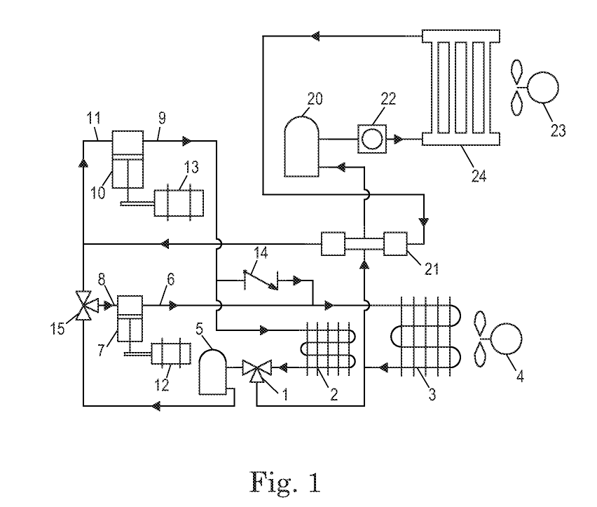

FIG. 1 is a block diagram of a High Ratio Mobile Electric HVAC System according to a first embodiment.

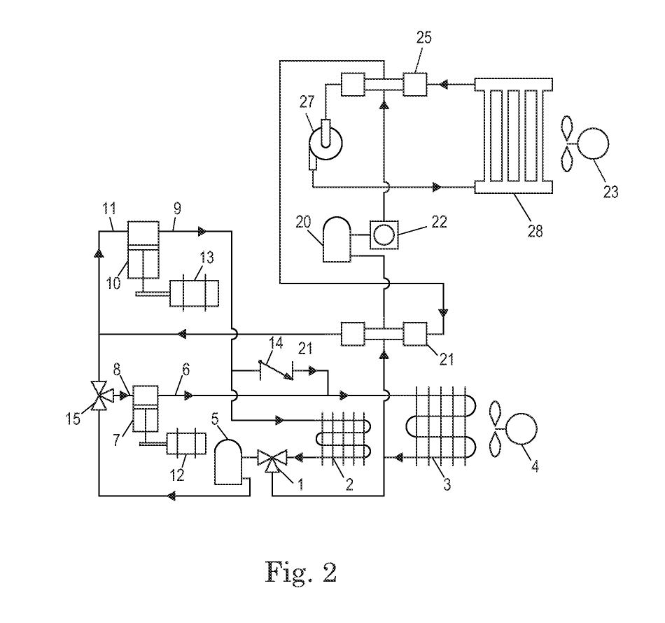

FIG. 2 is a block diagram of a High Ratio Mobile Electric HVAC System according to a second embodiment.

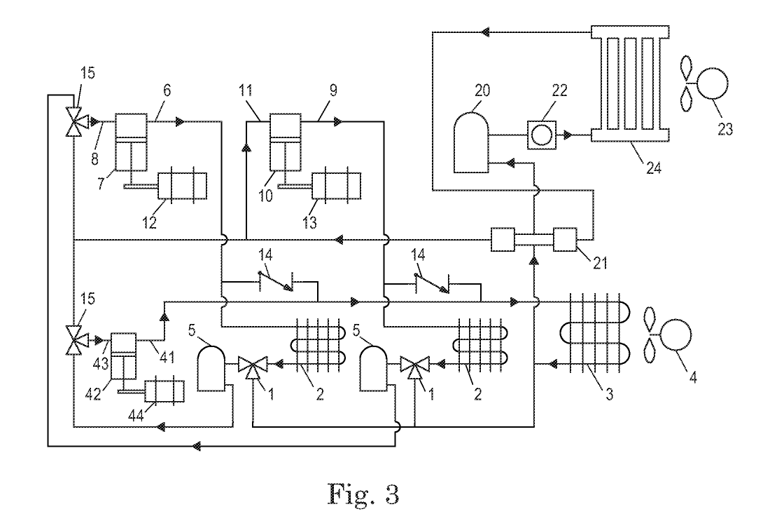

FIG. 3 is a block diagram of a High Ratio Mobile Electric HVAC System according to a third embodiment.

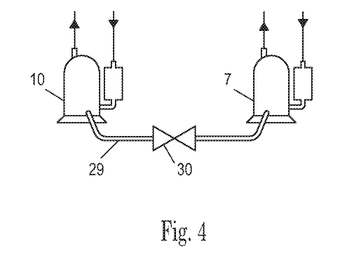

FIG. 4 is a block diagram of one embodiment of a compressor oil level equalization system.

FIG. 5A is a block diagram of the input power system of the prior art using an inverter and a 115 vac compressor.

FIG. 5B is a block diagram of the input power system of the prior art using a DC-DC converter and a high voltage DC compressor.

FIG. 5C is a block diagram of the input power system of the prior art using a low voltage DC compressor.

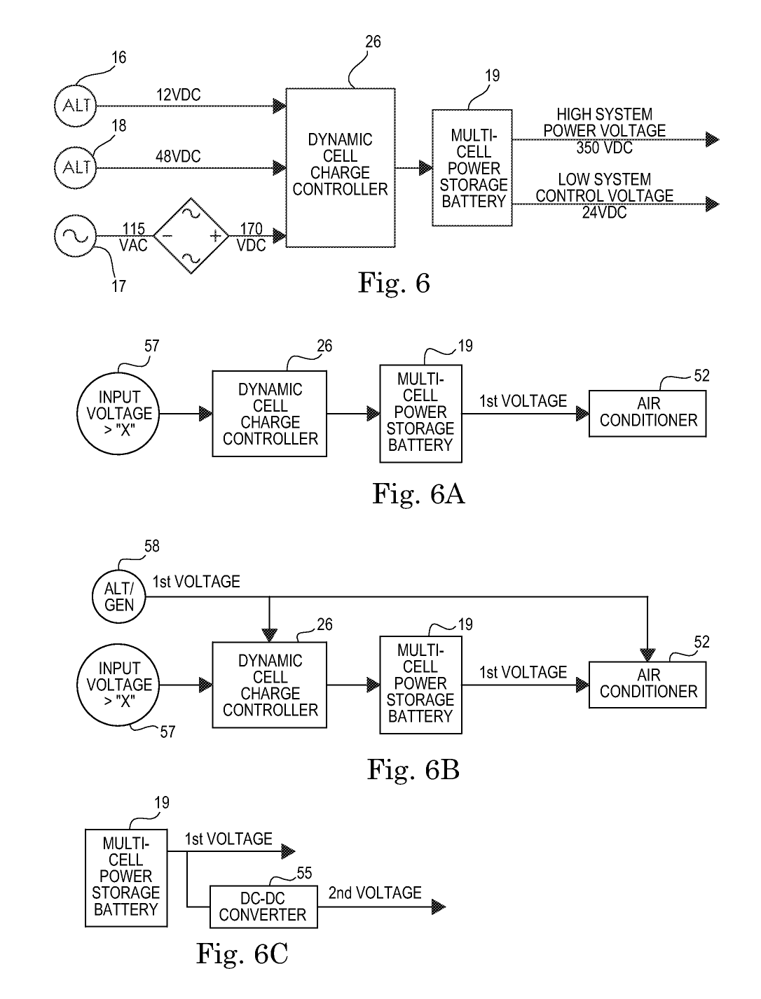

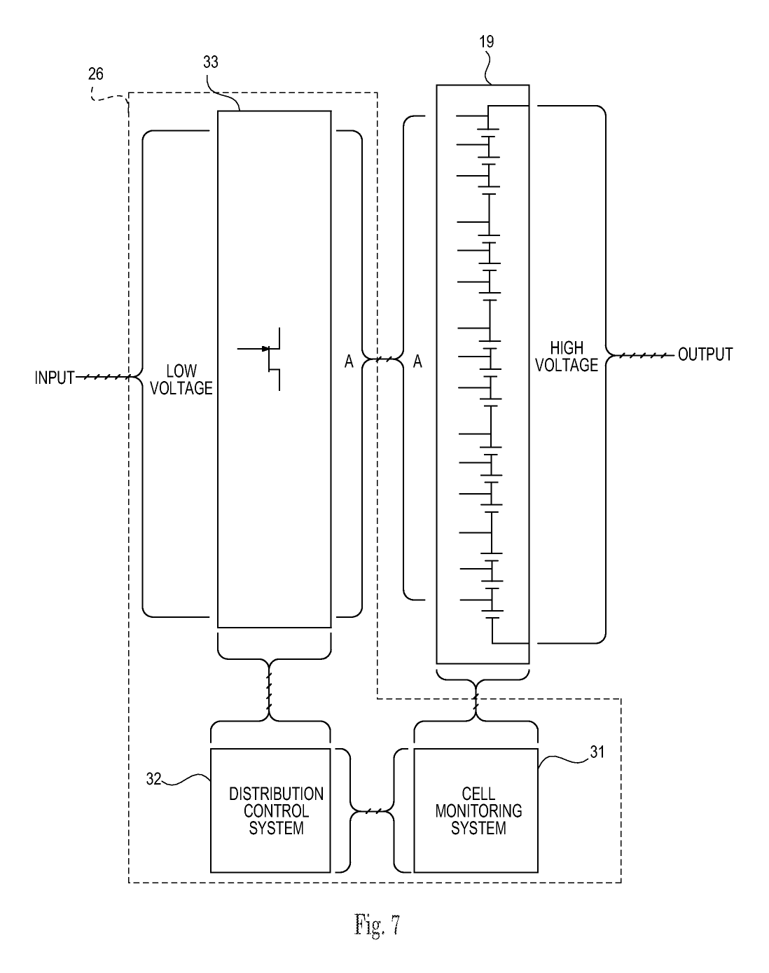

FIG. 6 is a block diagram of an input power system according to the first embodiment.

FIG. 6A is a block diagram of an input power system according to the second embodiment.

FIG. 6B is a block diagram of an input power system according to the third embodiment.

FIG. 6C is a block diagram of an input power system according to the fourth embodiment.

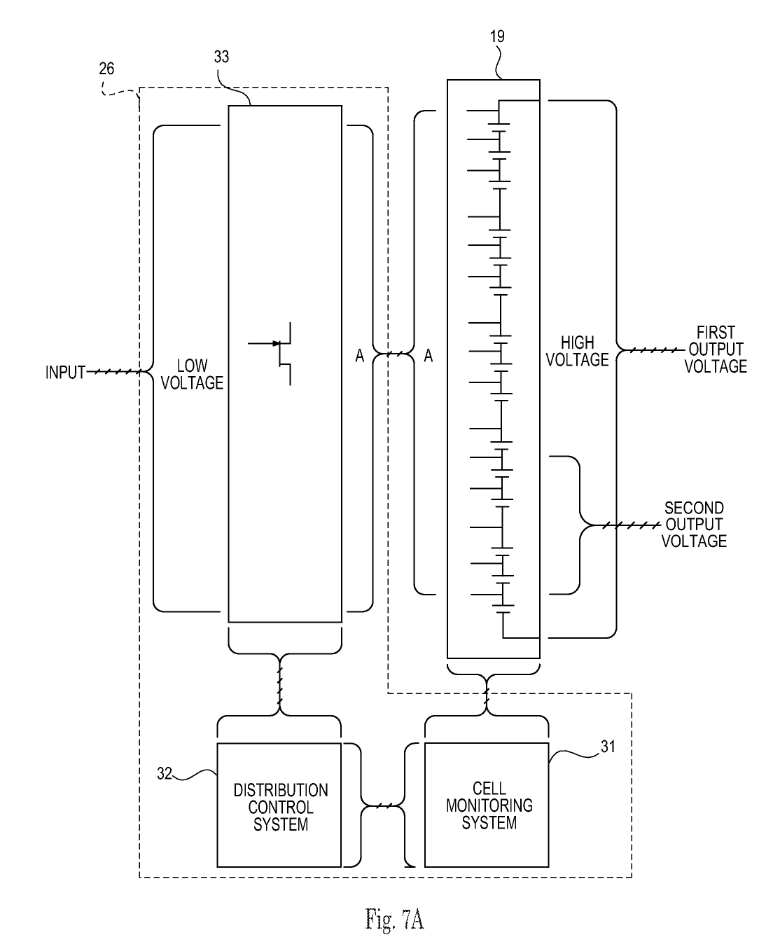

FIG. 7 is a block diagram of a Dynamic Cell Charge Controller integrated with a Multi-Cell Power Storage Battery statically configured for a single output voltage.

FIG. 7A is a block diagram of a Dynamic Cell Charge Controller integrated with a Multi-Cell Power Storage Battery statically configured for two output voltages. voltage.

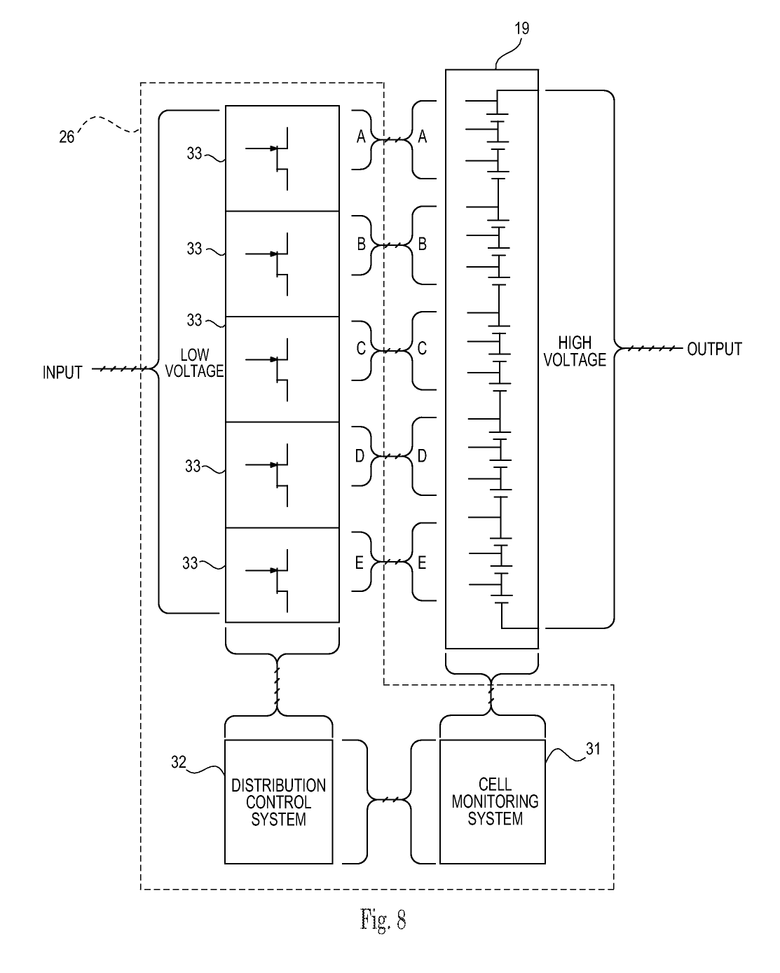

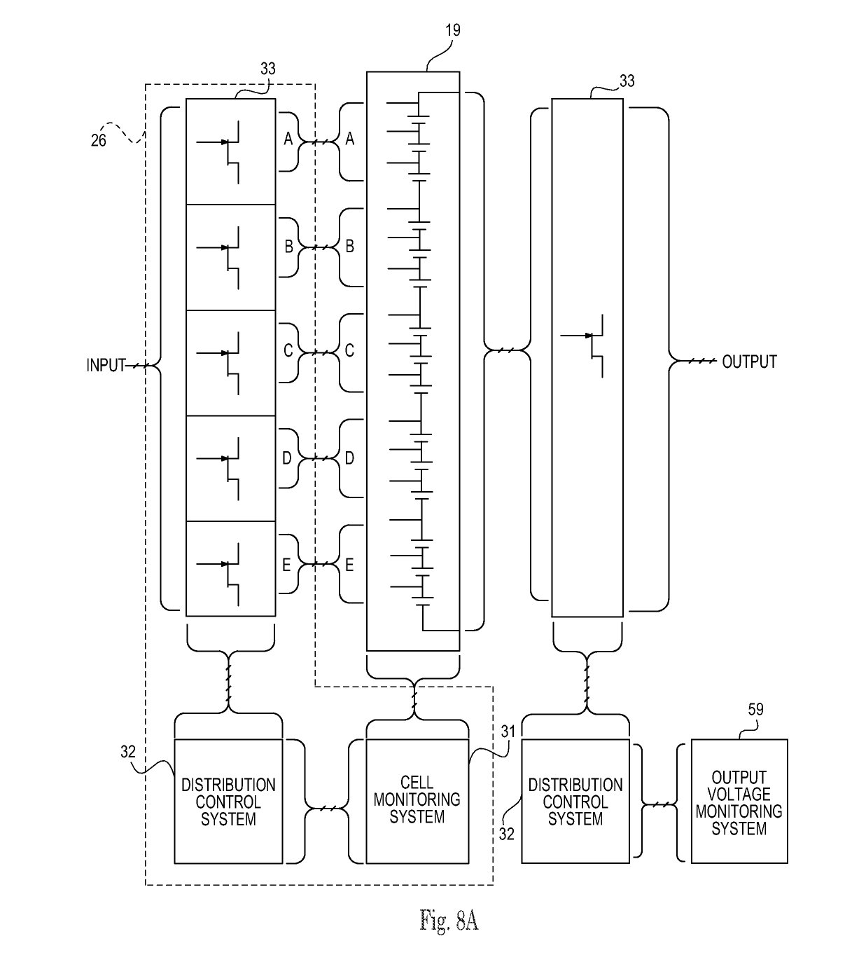

FIG. 8A is a block diagram of a Dynamic Cell Charge Controller auto-configured for 3-cell charge control integrated with a Multi-Cell Power Storage Battery dynamically configured for a single output voltage.

FIG. 8A is a block diagram of a Dynamic Cell Charge Controller auto-configured for 3-cell charge control integrated with a Multi-Cell Power Storage Battery dynamically configured for two output voltages.

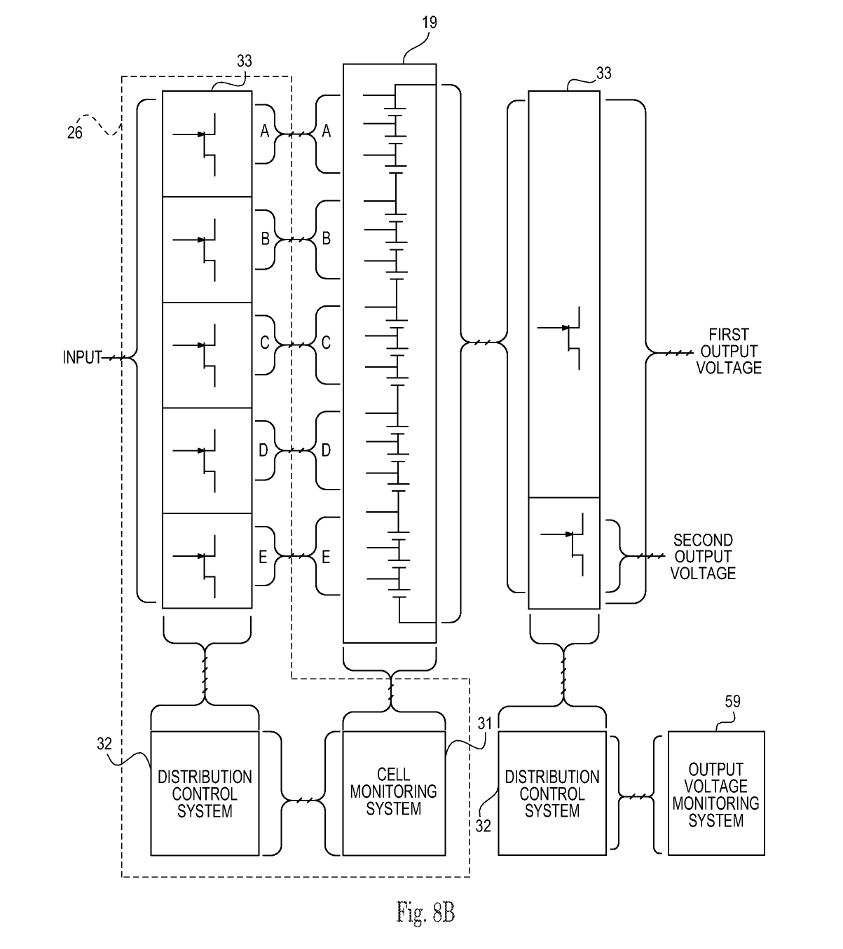

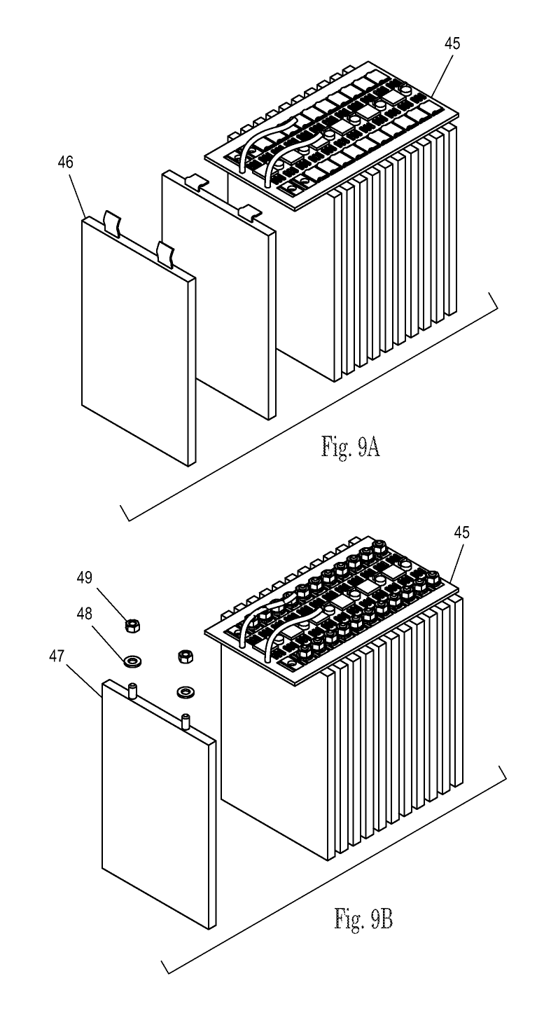

FIG. 9A shows a Dynamic Cell Charge Controller and Output Monitoring System integrated with a Multi-Cell Power Storage Battery with solder tab connections

FIG. 9B shows a Dynamic Cell Charge Controller and Output Monitoring System integrated with a Multi-Cell Power Storage Battery with screw terminal connections.

FIG. 10 is a block diagram of a first embodiment of a Hydronic Heating Circuit of a High Ratio Mobile Electric HVAC System.

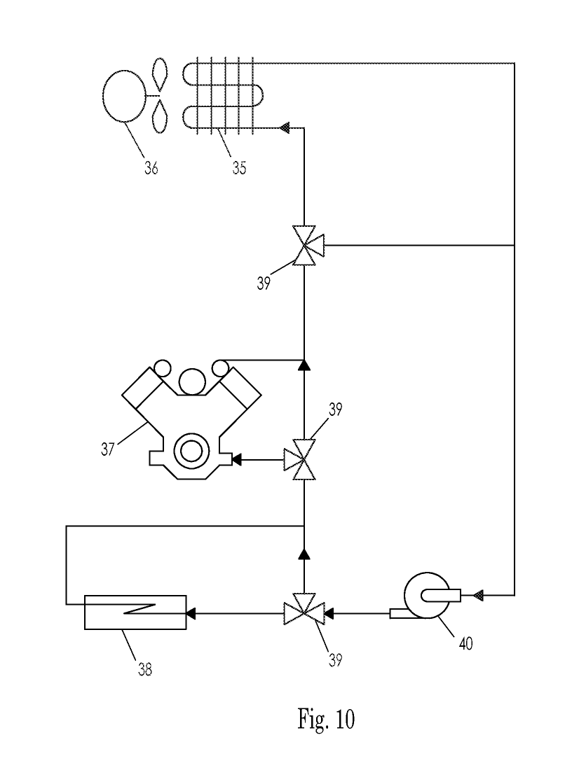

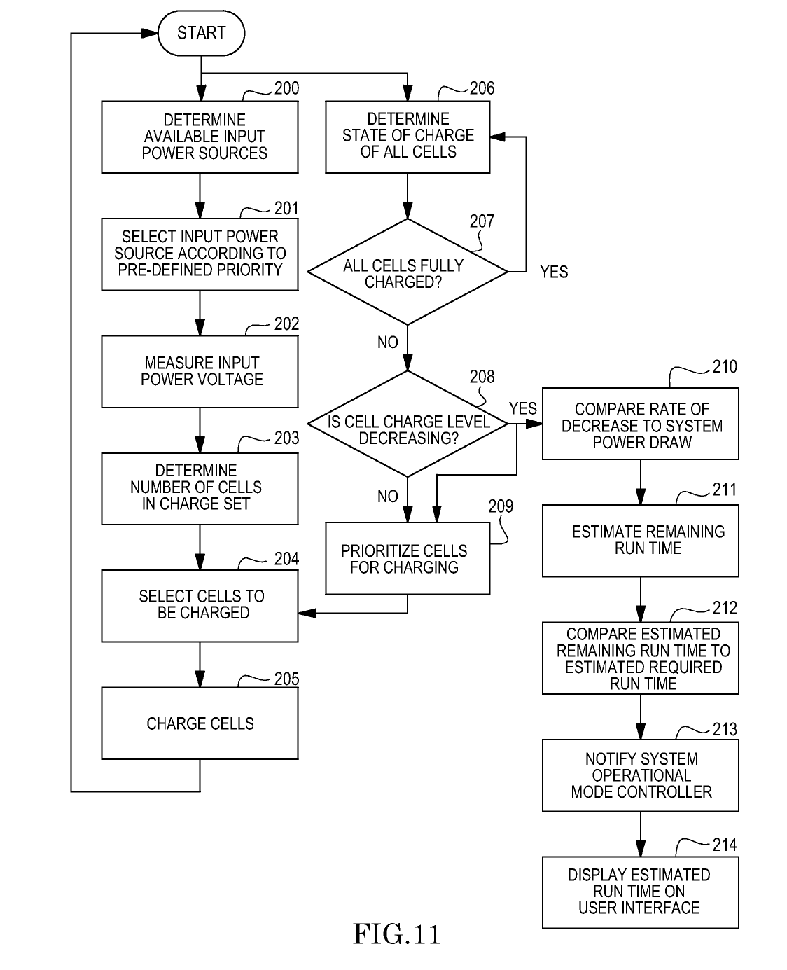

FIG. 11 is a logic flow chart for determining the input power selection and management according to a first embodiment of a Dynamic Cell Charge Controller.

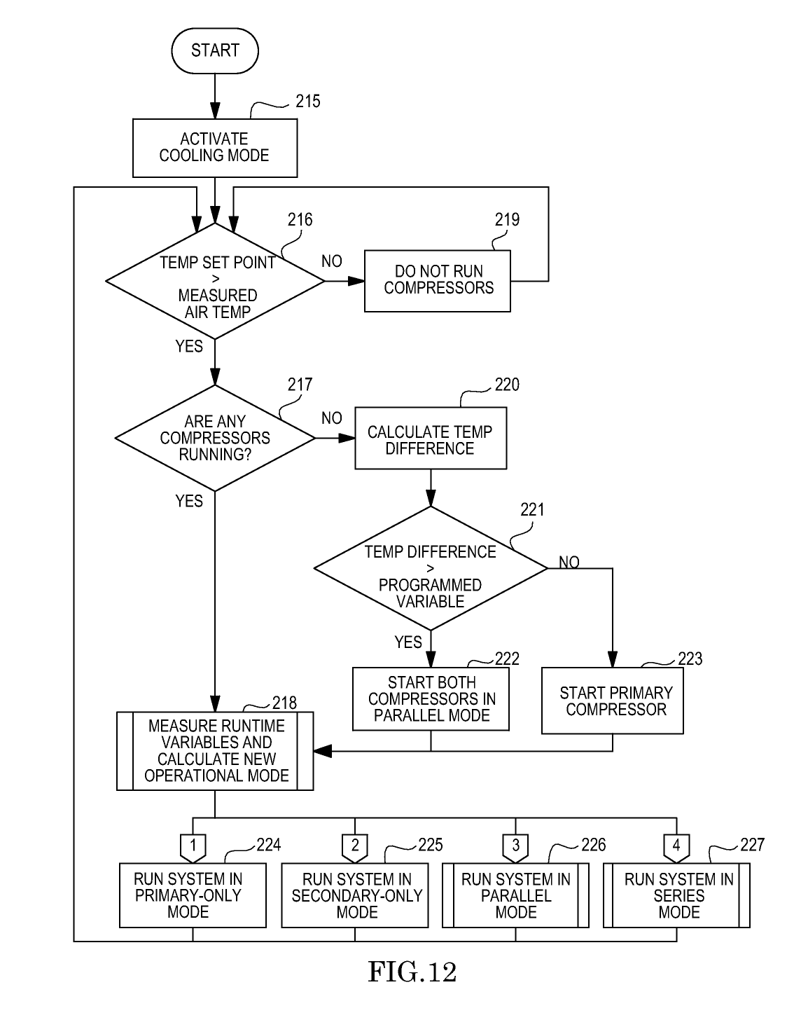

FIG. 12 is a logic flow chart for determining the compressor operation according to a first embodiment of a High Ratio Mobile Electric HVAC System.

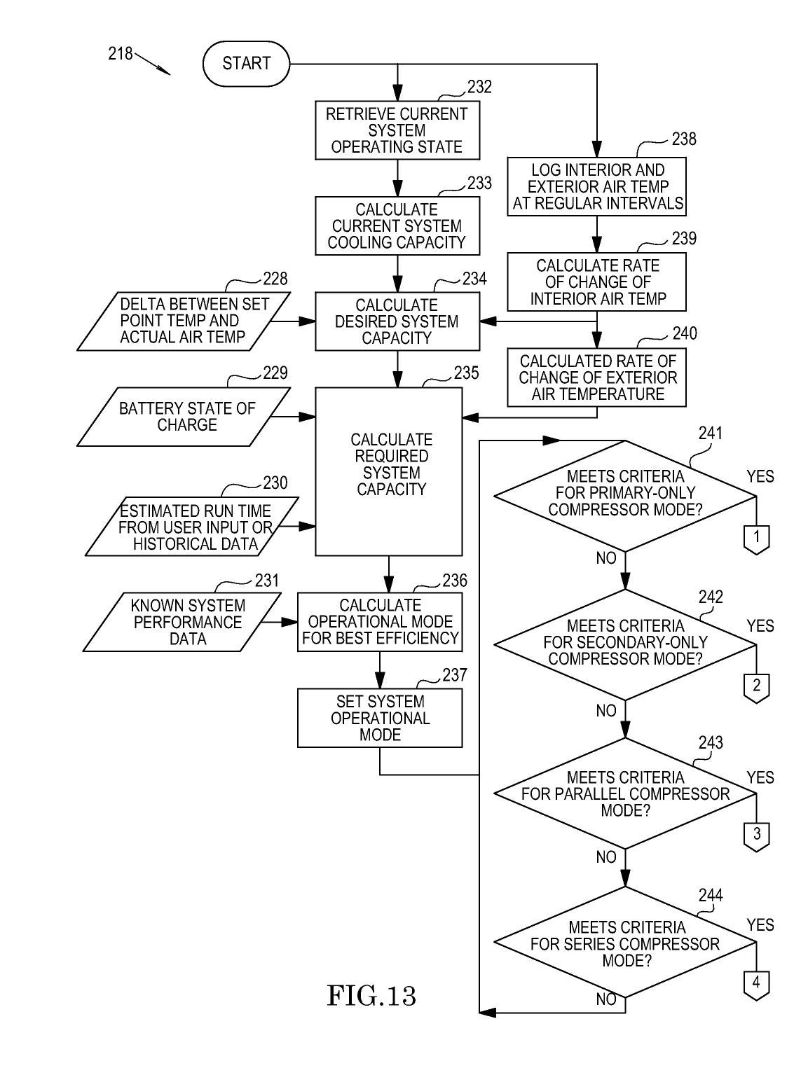

FIG. 13 is a logic flow chart for determining the system operating mode according to a first embodiment of a High Ratio Mobile Electric HVAC System.

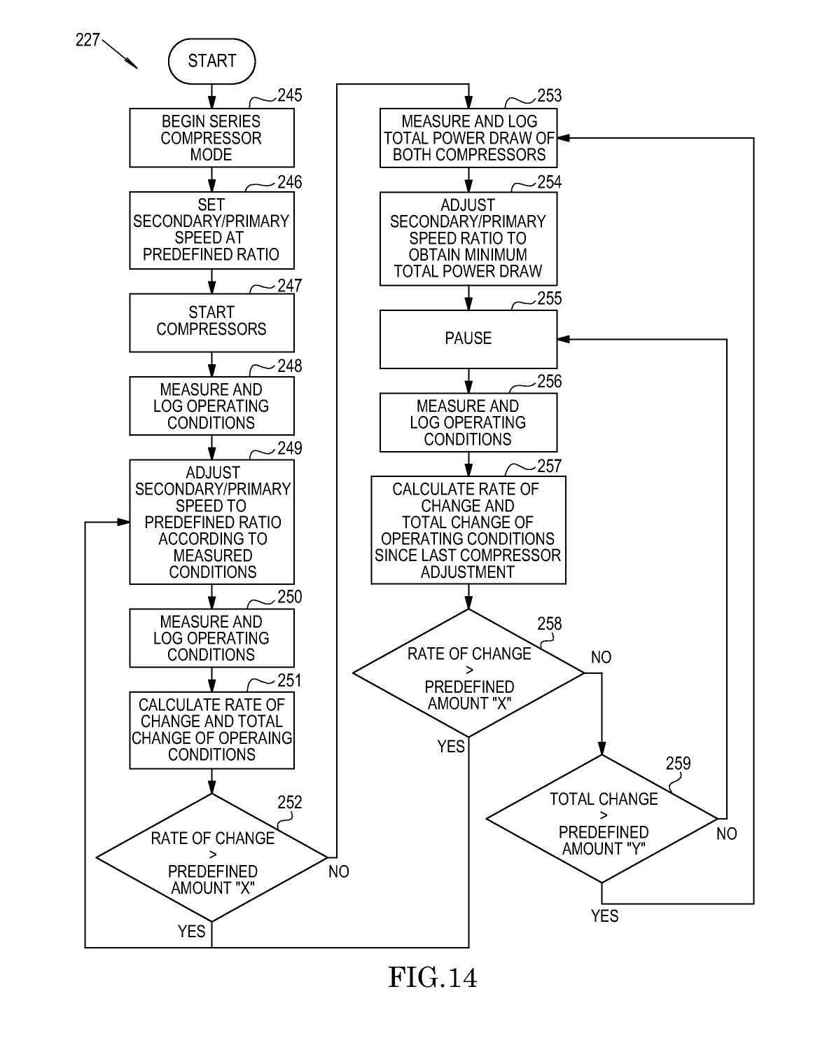

FIG. 14 is a logic flow chart for series compressor operating mode. according to a first embodiment of a High Ratio Mobile Electric HVAC System.

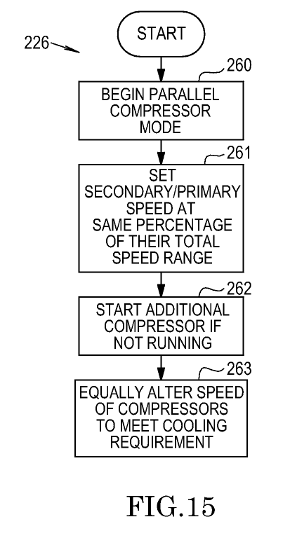

FIG. 15 is a logic flow chart for parallel compressor operating mode, according to a first embodiment of a High Ratio Mobile Electric HVAC System.

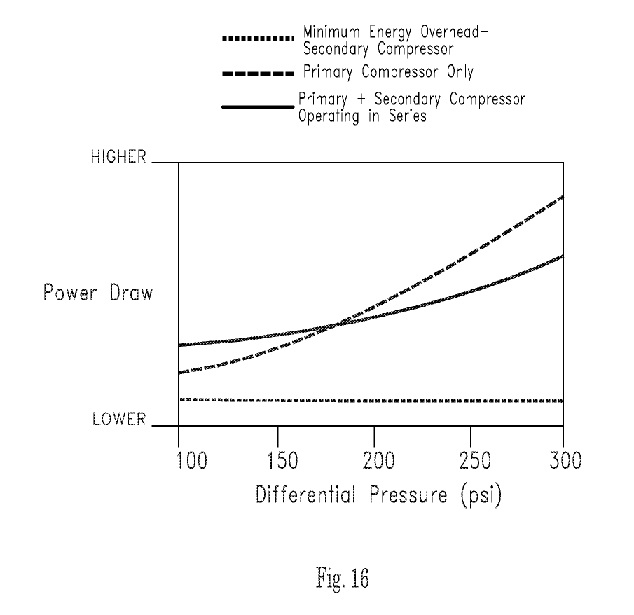

FIG. 16 is a chart showing the impact of differential pressure on power consumption at crossover capacities in single and series compressor modes.

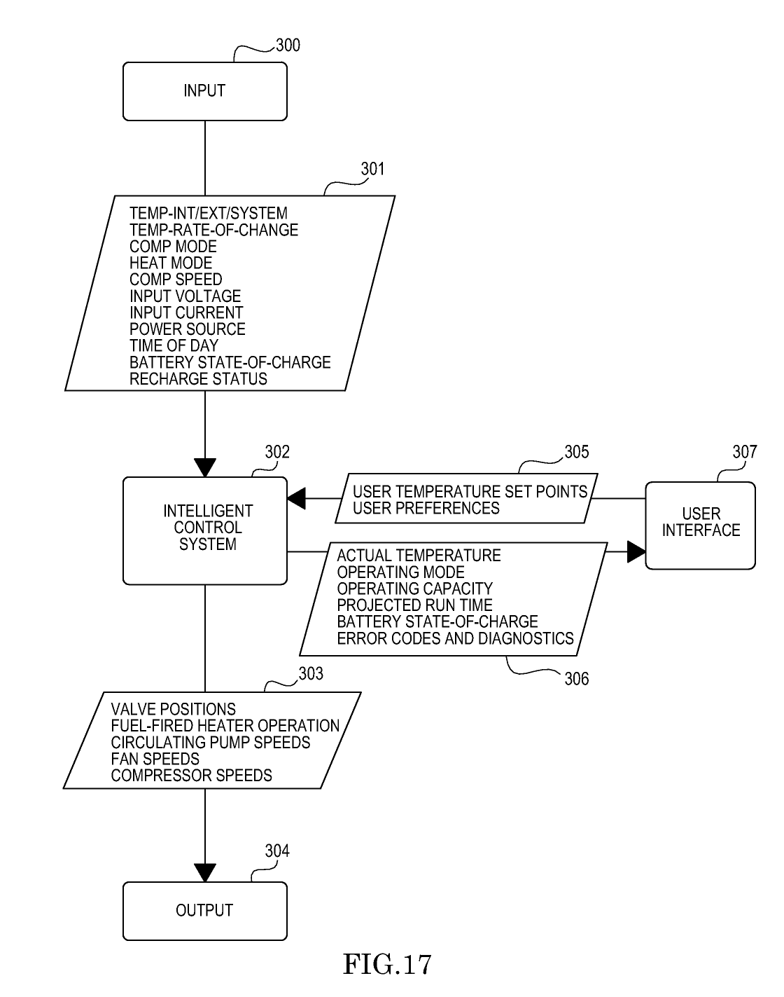

FIG. 17 is a block diagram of a User Interface and an Intelligent Control System.

### REFERENCE NUMBERS

1 3-way refrigerant liquid-gas flow control
2 Gas intercooler
3 Condenser coil
4 Condenser fan
5 Pressure buffer
6 Secondary compressor discharge
7 Secondary compressor
8 Secondary compressor inlet
9 Primary compressor discharge
10 Primary compressor
11 Primary compressor inlet
12 Secondary compressor motor
13 Primary compressor motor
14 Check valve
15 3-way refrigerant gas flow control
16 Vehicle power system source
17 Utility grid power source
18 Independent power source
19 Multi-cell power storage battery
20 Receiver
21 Sub-cooling heat exchanger
22 Evaporator refrigerant flow control
23 Cooling circuit fan
24 Direct expansion evaporator
25 Refrigerant—liquid evaporator
26 Dynamic cell charge controller
27 Liquid pump
28 Liquid-air heat exchanger
29 Compressor oil management circuit
30 Oil transfer control valve
31 Cell monitoring system
32 Distribution control system
33 MOSFET circuits
34 Intelligent control system
35 Liquid-air heat exchanger
36 Heater fan
37 Propulsion engine
38 Fuel-fired heater
39 3-way water flow control
40 Circulating pump
41 Tertiary compressor discharge
42 Tertiary compressor
43 Tertiary compressor inlet
44 Tertiary compressor motor
45 Circuit board
46 Battery cell with tab terminals
47 Battery cell with screw terminals
48 Washer
49 Nut
50 User interface
51 Inverter/Charger
52 Air conditioner
53 Truck 12 vdc
54 12 vdc aux. battery
55 DC-DC converter
56 AC-DC charger
57 Input power source
58 Alternator/Generator
59 Output voltage monitoring system

### DETAILED DESCRIPTION

### First Embodiment

A first embodiment of a High Ratio Mobile Electric HVAC System using R-410a refrigerant gas is illustrated in FIG. 1. Compression of the refrigerant is accomplished by two hermetically variable-speed compressors. A primary compressor 10 is operably connected to primary compressor motor 13 and has a maximum cooling capacity of 20 k btu/hr at maximum operating speed and a minimum capacity of 3.5 k btu/hr when operating at minimum speed. A secondary compressor 7 is operably connected to secondary compressor motor 12 and has a maximum cooling capacity of 6 k btu/hr at maximum operating speed and a minimum capacity of 1 k btu/hr when operating at minimum speed.

The total capacity and relative capacity of primary compressor 10 and secondary compressor 7 may vary in different applications and is a function of the minimum and maximum cooling requirement of a particular installation, the type and range of operating conditions and the type of refrigerant used. Primary compressor motor 13 and secondary compressor motor 12 are electronically commutated variable-speed motors.

Two electrically operated valves, 3-way refrigerant liquid-gas flow control 1 and 3-way refrigerant gas flow control 15 are operably positioned within the refrigerant circuit so as to selectably provide a series or a parallel connection between primary compressor 10 and secondary compressor 7. A gas intercooler 2 is a finned tube coil refrigerant-air heat exchanger sized to efficiently dissipate at least 50% of the total heat of rejection of primary compressor 10 when the system is in a series mode at full capacity and is positioned in the refrigeration circuit downstream from primary compressor discharge 9. Check valve 14 is sized to permit at least 70% of the maximum gas volume of primary compressor 10 to pass through with minimal pressure drop, and is operably connected so as to permit gas to flow in one direction from the refrigerant circuit of primary compressor discharge 9 to the refrigerant circuit of secondary compressor discharge 6.

Condenser coil 3 is an aluminum micro-channel refrigerant-air heat exchanger sized to efficiently dissipate at least 50% of the total heat of rejection of primary compressor 10 plus 100% of the total heat of rejection of secondary compressor 7 when the system is operating in parallel mode at maximum capacity. Condenser fan 4 is an axial fan powered by an environmentally sealed, variable-speed, permanent magnet motor and is operably positioned so as to circulate air from outside an interior compartment across condenser coil 3.

Pressure buffer 5 is an open reservoir such as a tube, having a volume at least 5× the single rotation displacement of primary compressor 10 and further having an inlet port to receive gas at the top and an outlet port positioned at the bottom so as to discharge gas in a manner that avoids trapping oil. It is functionally positioned so that, when the system is operating in series mode, gas pressure pulses from primary compressor 10 are smoothed and dissipated before the gas enters secondary compressor inlet 8.

Direct expansion evaporator 24 is a finned tube refrigerant-air heat exchanger sized large enough to efficiently extract heat from the air at the maximum capacity of the system when operating at full compressor speed in parallel mode. The design is self-draining so as not to trap oil when the system is operating for an extended period of time with a single compressor running at minimum speed. Receiver 20 is sized to contain the full refrigerant charge of the system. Liquid refrigerant is metered to the evaporator by evaporator refrigerant flow control 22 which is and electronic expansion valve sized to allow full transfer of refrigerant when the system is running at maximum capacity in parallel mode but is also able to precisely maintain evaporator superheat when the system is operating with a single compressor running at minimum speed. Cooling circuit fan 23 is a forward curved impeller powered by a variable-speed permanent magnet motor and is positioned to circulate air from an interior compartment over direct expansion evaporator 24.

The Compressor Oil Equalization System shown in FIG. 4 includes a compressor oil management circuit 29 which provides fluid communication between the oil sumps of primary compressor 10 and secondary compressor 7 to allow oil to flow in a controllable manner. An electronically controlled oil transfer control valve 30 controllably allows or prevents oil transfer between compressors.

Motive electrical power for the system is provided by the Inlet Power System shown in FIG. 6. DC power from a vehicle power system source 16 comes from the vehicle's primary power system which generally includes an engine-driven alternator and engine starting battery typically operating at a nominal voltage of 12 v. Additional DC power is provided by an independent power source 18 such as an engine driven alternator operating at a voltage higher, for example 48 vdc, than that of the vehicle's primary power system. A utility grid power source 17 originates at 115 vac and is enabled by an intermittent shore power connection when the vehicle is stationary and such a connection is available.

Dynamic cell charge controller 26 and multi-cell power storage battery 19 are shown in greater detail in FIG. 7A and FIG. 8B. Referring to FIG. 7A, a dynamic cell charge controller 26 includes a plurality of MOSFET circuits 33 (diagramed here a single circuit for simplicity) which are in electrical communication with and controlled by a distribution control system 32 according to the logic flow chart for input power selection and management as shown in FIG. 11. In this figure, two output voltages are statically configured by fixed circuits which tap some or all of the series string of cells.

FIG. 8B shows the state of the MOSFET circuits 33 when they have been auto-configured by distribution control system 32 according to the logic flow chart of FIG. 11 so as to receive input energy at a voltage to charge three-cell charge sets. The number of MOSFET circuits 33 in a particular embodiment of a dynamic cell charge controller 26 may vary in different embodiments. In the first embodiment, the number is the number required to individually control the flow of current to each and every cell in the multi-cell power storage battery. In other embodiments, the number is the number required to individually control the flow of current to the maximum number of multi-cell charge sets as determined by the minimum voltage input source. In this case, the maximum granularity of the charge control is a single smallest charge set rather than a single cell.

Cell monitoring system 31 monitors the individual cells in multi-cell power storage battery 19 and reports conditional information such as voltage, current flow, temperature and state-of-charge and stored historical data on past charge/discharge performance to distribution control system 32. Multi-cell power storage battery 19 is has an LiFePO4 chemistry. It is comprised of 110 individual cells. Each cell has a nominal voltage of 3.2 v and a peak charge voltage of 3.65 v. Connected in series, these calls give a nominal output voltage of 350 vdc which is used to drive the compressors of the system. A second output voltage is generated by dynamically selecting a sub-bank of 8 cells giving a 24 v nominal voltage for use in powering fans, pumps, controls and valves within the system.

Continuing to reference FIG. 8B, it can be seen to further include a means to dynamically control the output voltages through the addition of MOSFET circuits 33, a second distribution control system 32 and an output voltage monitoring system 59 on the output side of multi-cell power storage battery 19. In this figure, all of the cells tapped to produce the second output voltage are included in the series string which produces the first output voltage. In some configurations the cells are separate cells or partially common cells.

Therefore, the requirements of the first embodiment can be met with either with fixed static output circuits as shown in FIG. 7A or with dynamically configured output voltages as shown in FIG. 8A. When the output voltage is dynamically configurable, there exists a further option to use a larger number of cells than will be tapped as a series string at any one time. This allows cells to be held in reserve in the event that some cells fail. For example, a multi-cell power storage battery might include 130 cells. From these, a sub-bank of 110 cells is dynamically selected to provide the compressor voltage of 350 v and a second sub-bank of 8 cells is dynamically selected to provide the accessory voltage of 24 v.

FIG. 9A and FIG. 9B show how, according to a first embodiment dynamic charge and output circuit components may be integrated with a multi-cell power storage battery 19. All components of the dynamic cell charge controller 26 and the static output circuits or dynamic output circuits and components MOSFET circuits 33, distribution control system 32 and output voltage monitoring system 59, are incorporated onto circuit board 45. FIG. 8A shows how circuit board 45 is then electrically and mechanically integrated with individual battery cells with tab connections 46 using soldered connections. FIG. 8b shows the same board integrated with individual battery cells with screw terminals 47 using washer 48 and nut 49.

FIG. 10 is a block diagram of a Hydronic Heating Circuit according to a first embodiment. This heating circuit is functionally integrated with the air conditioning circuit of the High Ratio Mobile Electric HVAC System shown in FIG. 1. The components of the heater circuit and those of the air conditioning circuit are controlled through a common intelligent control system 34 and receive user data input and display user information via a common user interface 50 as shown in FIG. 17. A circulating pump 40 is a magnetically coupled centrifugal pump powered by a variable-speed permanent magnet motor available from Johnson Pump (Sweden) and others. It circulates a heat transfer fluid such as a 40/60 mixture of propylene glycol and water. Heat sources include the cooling circuit and exhaust system of vehicle propulsion engine 37 and a fuel-fired heater 38 which is available from Webasto, Espar and others. Flow is controlled by 3-way water flow controls 39 which are electrically activated water valves compatible with the water temperature of at least 130 degrees C. Liquid-air heat exchanger 35 is typically a finned copper coil and may, or may not, be co-located and physically integrated with direct expansion evaporator 24. Heater fan 36, a forward impeller blower powered by a variable-speed permanent magnet motor, circulates air from an interior compartment.

### Operation

### First Embodiment

A first embodiment of a High Ratio Mobile Electric HVAC System shown in FIG. 1 achieves an exceptionally high 26:1, turn-down ratio by operating two compressors in four different modes—primary only, secondary only, primary and secondary in series and, lastly, primary and secondary in parallel. The benefit of this high turn-down ratio and multi-compressor capability is that the capacity of the system can be closely and most efficiently matched to the wide-ranging heat load common to mobile vehicles operating in on-highway and no-idle conditions. Given the particular compressor selection of the first embodiment, Table 1 shows the range of capacities that are available in each mode.

TABLE 1

| Compressor & mode | Capacity Range (btu/hr) |
|---|---|
| Secondary only | 1,000-6,000 |
| Primary only | 3,350-20,000 |
| Primary and Secondary in series | 4,000-22,000 |
| Primary and Secondary in parallel | 4,500-26,000 |

Intelligent control system 34 receives information from user interface 50, dynamic cell charge controller 26 and other internal and external sensors as shown in FIG. 17. Using real time data and stored data from past operating cycles, Intelligent control system 34 balances a variety of physical characteristics of electrically power air conditioning systems as described in Table 2 and further shown in FIG. 16 to provide real-time system control according to the logic flow charts shown in FIG. 12, FIG. 13, FIG. 14 and FIG. 15.

TABLE 2

| Factor | Description and Effect |
|---|---|
| High-side pressure | is a function of ambient exterior air temperature and the required |
| | cooling capacity. Increasing high-side pressure consumes more |
| | power, reduces system capacity and makes series operation more |
| | beneficial. |
| Low-side pressure | is a function of ambient interior air temperature and required cooling |
| | capacity. Reducing low-side pressure consumes more power, |
| | reduces system capacity and makes series operation more beneficial. |
| Differential pressure | is the difference between high-side and low-side pressure. Greater |
| | differential pressure consumes more power, reduces system capacity |
| | and makes series operation more beneficial. |
| Friction | increases at approximately the square of the compressor rotational |
| | speed. Operating two compressors in parallel allows lower rotational |
| | speed than either a single compressor or two compressors operating |
| | in series to achieve the same cooling capacity. Discounting the |
| | impact of other factors, friction may be minimized in parallel operation. |
| Motor iron losses | results from the formation of eddy currents which occur in the motor |
| | laminations as a result of alternating currents. Higher frequency |
| | results in higher losses. When delivering the same cooling capacity, |
| | two compressors operating in parallel generally have lower combined |
| | iron losses than either a single compressor running alone or two |
| | compressors operating in series. |
| Minimum energy | is imposed whenever an additional compressor is started even when |
| overhead | that compressor is doing no effective work. Operating a single |
| | compressor eliminates this overhead. |

When electrically commanded by intelligent control system 34, 3-way refrigerant liquid-gas flow control 1 and 3-way refrigerant gas flow control 15 are positioned to operably connect primary compressor 10 and secondary compressor 7 in parallel or in series. In parallel connection, a refrigerant gas such as R-410a is compressed from an evaporating pressure to a condensing pressure by primary compressor 10 and secondary compressor 7.

Looking first at the operation of primary compressor 10, gas discharged from primary compressor discharge 9 flows through two separate discharge paths. The first discharge past leads to gas intercooler 2 and through 3-way refrigerant liquid-gas flow control 1 which is intelligently positioned to provide fluid communication with the second path downstream of condenser coil 3. The second discharge path leads through check valve 14 and condenser coil 3. Therefore, in parallel operating mode, condenser coil 3 and gas intercooler 2 operate in parallel to condense the refrigerant discharge gas of primary compressor 10.

Continuing in parallel operating mode and looking now at the operation of secondary compressor 7, refrigerant gas compressed by secondary compressor 7 is discharged through secondary compressor discharge 6 into the said second discharge path of primary compressor 10. The discharged gases, now combined, and enters condenser coil 3 as described above and is condensed. The now condensed and liquified refrigerant from the first discharge path and the second discharge path combine in a common circuit which, being in fluid communication with receiver 20, allows the liquid refrigerant from both compressors to enter receiver 20.

In parallel operating mode, primary compressor 10 and secondary compressor 7 may be operated individually or simultaneous at any speed to provide the desired capacity.

Looking now at the operation of the system in series operating mode, refrigerate gas is pressurized by primary compressor 10 to an intermediate pressure, the intermediate pressure being a pressure greater than the evaporating pressure but less than the condensing pressure. Upon exiting primary compressor discharge 9, the refrigerant gas enters and is cooled by gas intercooler 2. In series operating mode, gas intercooler 2 cools and reduces the pressure of the refrigerant discharged from primary compressor 10 but does not condense it.

Upon exiting gas intercooler 10, the now cooled refrigerant gas enters a-way liquid-gas flow control 1 and is directed to pressure buffer 5. Pressure buffer 5, reduces the fluctuations in pressure that are common to the inlet and discharge lines pulsating refrigerant compressors. 3-way refrigerant gas flow control 15 is now positioned to provide fluid communication between the discharge of pressure buffer 5 and secondary compressor inlet 8.

The refrigerant gas, having been discharged from primary compressor 10 at an intermediate pressure, and having been cooled by gas intercooler 2 and pressure equalized by pressure buffer 5, enters secondary compressor 7 and is further compressed to the condensing pressure. Secondary compressor discharge 6, being in fluid communication with condenser coil 3, allows gas discharged at the condensing pressure to enter condenser coil 3 where it is cooled and liquified. The exit port of condenser coil 3, being in fluid connection with receiver 20, allows the liquid refrigerant to enter receiver 20.

From this point, the fluid path remains the same in all operating modes. Liquid refrigerant, having entered and been held in reserve in receiver 20 is discharged to evaporator refrigerant flow control 22 and selectively metered to direct expansion evaporator 24. Therein, upon receiving heat from the air of an interior compartment circulated by cooling circuit fan 23, the liquid refrigerant evaporates to a gas. The gas, now at evaporating pressure, passes through sub-cooling heat exchanger 21 and removes heat from the condensed liquid refrigerant with which it is in thermal communication.

The gas returns to the operating compressor(s) via primary compressor inlet 11 and secondary compressor inlet 8. The source of gas returning to secondary compressor inlet 8 is determined by 3-way refrigerant gas flow control 15 which is positioned by the intelligent control system 31 to source gas from gas intercooler 2 in a series operating mode and from direct expansion evaporator 24 in a parallel operating mode.

In a heating mode, heat enters a liquid heat transfer loop as shown in FIG. 10. The heat transfer fluid transfers heat entering the system through heat exchange interfaces at a plurality of heat-generating sources including the cooling circuit of vehicle propulsion engine 37 and fuel-fired heater 38. The fluid is circulated by circulating pump 40 and controlled by 3-way water flow controls 39 so as to flow through or by-pass operating and non-operating heat generation sources. Upon reaching a temperature set at user interface 50, a heating command from intelligent control system 34 activates circulating pump 40 and positions 3-way water flow controls 39 so as to direct the heated heat transfer fluid through a liquid-air heat exchanger 35. In various installations, liquid-air heat exchanger 25 may be co-located and physically integrated with direct expansion evaporator 24. In all installations, heater fan 36, a forward impeller blower powered by a variable-speed permanent magnet motor, circulates air across liquid-air heat exchanger 35 to provide heat to an interior compartment. In the event that liquid-air heat exchanger 35 is co-located with direct expansion evaporator 24, one of heater fan 36 and cooling circuit fan 23 becomes redundant and may be eliminated.

Operation of the Input Power System shown in FIG. 6 is further clarified by referring to FIG. 7A, FIG. 8B and FIG. 11. Electrical power is generated and enters the system from three sources. A vehicle power system source is the main vehicle power system source 16. This is typically includes an engine-driven alternator and vehicle battery. It may further include a auxiliary power source such as an internal combustion engine-powered generator, fuel cell or solar array. These sources are integrated and typically operate at a nominal voltage of 12 vdc.

A second power source is independent power source 18 has an output voltage higher than that of main vehicle power system source 16. It is typically fully independent but in some configurations may indirectly supply power to other vehicle systems through a DC-DC converter. In this embodiment it is an engine-driven alternator outputting power at 48 vdc nominal. It may also be a regulated or unregulated permanent magnet generator or an auxiliary power source such as an internal combustion engine-powered generator, fuel cell or solar array

A third power source is utility grid power source 17 which, originating as 115 vac power, is rectified to 170 vdc power. All three sources of power may or may not be available at the same time. Dynamic cell charge controller 26 receives 200 and prioritizes 201 all power sources as shown in the Logic Flow Chart of FIG. 11. Power source priority is determined according by a combination of pre-programmed preferences and real-time operating conditions. For example, if utility grid power source 17 is available it might be preprogrammed and used as the first preferred source of power. If it were not available, either main vehicle power system source 16 or independent power source 18 might be selected as the preferred power source according to such real-time conditions as the power required by the subject invention or such other loads as may be on one or both of these power sources.

Having now selected a preferred power source, dynamic cell charge controller 26 measures the actual input voltage of the source 202. For example, main vehicle power system source 16 has a nominal voltage of 12 vdc but a precise voltage of 13.10 vdc. Individual cells of multi-cell power storage battery 19 each require a charge voltage of 3.65 v and have a float voltage of 3.20 v. To determine the number of cells in the charge set 204, the precise power source voltage (13.10 v) is divided by the charge voltage of an individual cell (3.65v). The number of cells in the charge set is equal to the whole number of the sum (3). FIG. 8 shows a dynamic cells charge controller 26 auto-configured to charge 3-cell charge sets based on a power source input voltage of 13.10 v. The number of charge sets which may be changed at any given time is determined by the amount of power available from the input source and the amount of current that each charge set will draw.

As power is drawn from multi-cell power storage battery 19, the voltage of the individual cells and the series connected battery falls. For many reasons such as manufacturing variances and internal resistance, the voltage of some cells will fall faster than others. Cell monitoring system 31 uses real-time cell voltage, current flow and temperature in conjunction with historical performance data from previous charge/discharge cycles, to determine and report the state of charge of each cell to distribution control system 32. The cells are then prioritized for charging 209 so that the cells with the lowest state of charge are charged first.

Distribution control system 32 turns on and off MOSFET circuits 33 so as to allow current to flow to the cells in the charge set(s). In many cases, the total charge voltage available exceeds the optimum charge voltage of a charge set. Similarly, individual cells in a charge set may require different charge voltages based on variance their state of charge. To adjust the charge voltage of each cell, distribution control system 32 commands the corresponding MOSFET circuit 33 to be partially turned on rather than fully turned on. A partially turned on MOSFET adjusts the voltage to the cell or, in some embodiments to the charge set, by acting as a variable resistor according to the more or less fully turned on by varying the strength of the gate drive circuit.

Because all input power sources have a limit on the amount of current that can safely be drawn, distribution control system 32 increases or decreases the number of charge set of cells that are charged at any one time so that the optimum amount of total power is drawn from the input power source.

In operation, Input Power System of FIG. 6 may simultaneous be in functioning in different modes relative to different cells and charge sets as shown in Table 3. This ensures that power may be passed through the system without causing damage due to overcharging.

TABLE 3

| Mode | Function |
|---|---|
| Charging battery - system off | Cells are maintained at charge voltage, |
| | no additional power drawn |
| Charging battery - system on | Cells are maintained at charge voltage |
| | while power is drawn |
| Battery charged - system on | Cells are maintained at float voltage |
| | while power is drawn |
| Battery charged - system off | Cells are maintained at float voltage or |
| | disconnected from input power |

Two output voltages are produced by making two different series connections to the cells of multi-cell power storage battery 19. A high voltage of 350 vdc is produced by a series connection of 110 individual cells. A low voltage of 24 vdc is produced by a series connection of 8 individual cells. The high voltage is used to efficiently power high power components such as primary compressor 10 and secondary compressor 7 at a low current. The low voltage is used to safely power low power devices such as 3-way flow controls 1, 15 and 39, circulating pump 40 and fans 23, 39 and 4 as well as other electronic control and mechanical devices.

The series connections to multi-cell power storage battery 19 which are required to produce the two output voltages may be either static or dynamic. Two static output connections are shown in FIG. 7A. These connections are fixed in that the specific cells which are tapped to create each voltage are determined by the placement of wires or printed circuits and cannot be readily changed. Two dynamic voltage outputs as shown in FIG. 8B allow both the specific voltages to be changed as well as the choice of cells which are tapped to produce those voltages. In a dynamic output system, MOSFET circuits 33 are used to operably connect and disconnect individual cells on the output side just as they are on the input (charge) side. Also, as with the input side, the MOSFET circuits 33 used on the output side are turned on and off to select the desired cells and provide the desired output voltage by a distribution control system 32. An output voltage monitoring system 59 monitors the output voltage and current of each cell as well as the series string.

A further benefit of the dynamic output voltage system is that the real-time and logged historical voltage and current data from output voltage control monitoring system 59 can be used in conjunction with similar data from cell monitoring system 31 on the charge side to further understand and monitor the condition of the individual cells. Additionally, the output voltage can be altered in real time in response to changing conditions. For example, in some types of motors and control circuits it is more efficient to use a lower or higher voltage as the load and/or speed changes. In a system using controllable output voltage, the voltage of one or more output circuits can be changed to optimize efficiency or to replace expensive control circuits on certain types of devices.

### Second Embodiment

A second embodiment of a High Ratio Mobile Electric HVAC System is shown in FIG. 2 and incorporates a chilled water heat transfer loop to permit all refrigerant-containing components to be fully located outside the interior compartment. The direct expansion evaporator 24 of the first embodiment is replaced by a refrigerant-liquid heat exchanger 25 which is in fluid and thermal communication with the refrigerant circuit and with a circulating heat-transfer fluid. Similarly, the direct expansion evaporator 24 of the first embodiment is replaced by a liquid-air heat exchanger 28. Liquid pump 27, which is a centrifugal pump magnetically coupled to a permanent magnet variable-speed motor, circulates a heat transfer fluid such as a 40/60 mixture of propylene glycol and water though liquid-air heat exchanger 28 and through refrigerant liquid heat exchanger 25. The thermal effect is that heat from the air of an interior compartment, circulated by cooling circuit fan 23, enters the heat transfer fluid through liquid-air heat exchanger 28. Liquid pump 27 circulates the now-heated heat transfer fluid to refrigerant-liquid heat exchanger 25 when it is absorbed by the boiling refrigerant. The balance of the operation of the second embodiment remains as described above in the description of the first embodiment.

The Input Power System is as shown in FIG. 6A includes an input power source 57 which may be any source of electric power with a voltage greater than “X”, voltage “X” being the minimum charge voltage of a single cell of multi-cell power storage battery 19. A first voltage is generated by a series connection of a plurality of cells of multi-cell power storage battery 19 and is a voltage required to power air conditioner 52. Air conditioner 52 is so defined to provide consistency with the documented description of the prior art but is the same as the subject invention. The said plurality of cells may or may not be all of the cells of multi-cell power storage battery 19. If the said plurality of cells is less than all of the cells of multi-cell power storage battery 19 then the said series connection is a dynamically configurable connection in the same manner as shown for dynamic cell charge controller 26, such that different charge sets of cells may be selected.

The operation of the input power system can be better understood in reference to FIG. 7 and FIG. 8. Input voltage at “X” volts is monitored by distribution control system 32. Following the formula previously described in the first embodiment, MOSFET circuits 33 (shown here as one circuit for simplicity) are opened and closed so as to correctly create the number and composition of cell charge sets for charging. FIG. 8 shows the system auto-configured by distribution control system 32 to charge charge sets of three cells each based on an input voltage of 13.10 v. The output voltage is a single fixed output at a first voltage determined by the number of cells in the series string.

### Third Embodiment

FIG. 3 shows a third embodiment of a High Ratio Mobile Electric HVAC System incorporating three compressors—a primary, a secondary and a tertiary compressor to achieve a stepless turn-down ratio of 258:1. As with the first embodiment, compressors may operate in parallel or series modes. Three compressors offer a much greater number of potential combinations than two compressors and offer a larger turn-down ratio covering a stepless capacity range which is 10× greater. In addition to running the compressors singly, in series and in parallel, three compressor offers the further possibility of running a combination of parallel and series. For example, two compressors in series and running that in parallel with the third compressor. The main governing factors determining what combinations are beneficial will be the compression ratio and the range of the load. One possible compressor capacity selection is shown in Table 3.

TABLE 3

| Compressor & mode | Capacity Range (btu/hr) |
|---|---|
| Tertiary only | 500-3,000 |
| Secondary only | 3,000-18,000 |
| Primary only | 18,000-108,000 |

System layout and the operating of three compressors is otherwise as shown in FIG. 3 and as described in the detained description and operation of the first embodiment.

A third embodiment of an Input Power System is shown in FIG. 6B and has an input side identical to the second embodiment (FIG. 6A) except for the addition of a second input power source, alternator/generator 58. Alternator/generator 58 is a source of power such as an engine-driven generator or a storage battery which generates power at a first voltage. The first voltage being the operating voltage of air conditioner 52 and a voltage greater than “X” and less than, equal to or greater than the voltage produced by input power source 57. Consistent with the description of the second embodiment, “X” is the minimum charge voltage of a single cell of multi-cell power storage battery 19.

In the third embodiment, input power to air conditioner 52 and the subject invention is supplied through dynamic cell charge controller 26 and multi-cell power storage battery 19 as described in the first embodiment. It may also be supplied under certain operating conditions directly from alternator/generator 58. In still other operating conditions it may be flexibly supplied by a combination of both. For example, if alternator/generator 58 is an unregulated permanent magnet generator it is a characteristic of the technology to have a higher or lower voltage when the rotational speed is changed or when the load is changed. In such a case the output voltage of multi-cell power storage battery 19 may be dynamically adjusted relative to the output voltage of alternator/generator 58 by including a greater of lesser number of cells in the series string. By changing the output voltage of multi-cell power storage battery 19 relative to alternator/generator 58, the percentage of the total power which may be drawn from each is controlled. Alternately, the number of cells in series connection and, subsequently, the output voltage of multi-cell power storage battery 19 may be constant and control provided by altering the output of alternator/generator 58.

FIG. 8A is shows dynamic cell charge controller 26 auto-configured to supply power to 3-cell series connected charge sets within multi-cell power storage battery 19 based on an input voltage of 13.10 v supplied by input power source 57. When dynamic cell charge controller 26 selects alternator/generator 58 as the input power source, distribution control system 32 will identify the change in voltage and reconfigure MOSFET circuits 33 to recreate and optimize new series connected charge sets within multi-cell power storage battery 19 to match the requirements of the new input voltage according to the formula previously described in the first embodiment. For example, if alternator/generator 58 were to produce a first voltage of 350 vdc, MOSFET circuits 33 would be activated so as to produce a series string of 95 cells (350 input voltage/3.65 peak cell charge voltage=95).

Continuing in reference to FIG. 8A, a second distribution control system 32, an output voltage monitoring system 59 and an array of MOSFET circuits 33 (shown here as one circuit for simplicity) on the output side of multi-cell power storage battery 19 provides a dynamically variable single output voltage. This permits, in a condition where the energy stored in multi-cell power storage battery 19 is used in combination with the power output of alternator/generator 58 to provide the system motive power, the two power sources to regulate and adjust the relative level of power contribution of each.

### Fourth Embodiment

The fourth embodiment is shown in FIG. 6C and illustrates how a DC-DC converter 55 can be used as an alternative method of creating a multiple voltage power source by providing a second voltage from a first voltage.

### Advantages

In view of the limitations of the prior art, there is a need for a mobile electric HVAC system which can optimally meet the cooling requirements of both on-highway and no-idle operation. The invention described in this application;
(a) has a maximum capacity sufficient to meet the needs of an on-highway truck HVAC system without reduced functionality and/or energy efficiency when operating at minimum no-idle conditions.
(b) can, using a plurality of conventional mass-market compressors which are individually limited to a turn-down ratio no greater than 6:1, provide an HVAC system which can be steplessly varied in capacity between at least 1,000 btu/hr and 26,000 btu/hr.
(c) avoids the cost and other problems associated with high current operation by using an on-highway input power source with a voltage higher than the operating voltage of the truck's electrical system.
(d) provides a means that both, permits the use of input power from multiple sources operating at different voltages and, ensures long storage battery life by optimizing charging on a cell-by-cell basis.
(e) gives increased functionality and power options by providing a dynamically variable output voltage from a static or variable input voltage.
(f) minimizes the cost of power electronics by operating compressors at a voltage higher than the intrinsically safe voltage while simultaneously maximizing system safety by using external power sources that operate below the intrinsically safe voltage without the losses normally associated with DC-AC or DC-DC power conversion.
(g) uses the same battery charging and storage components in a shared functionality to boost the voltage from the on-highway power generation source during continuous on-highway operation.

### CONCLUSIONS, RAMIFICATIONS AND SCOPE

Accordingly, the reader will see that the High Ratio Mobile Electric HVAC System of the various embodiments can be used to energy-efficiently and cost-effectively meet all of the HVAC needs of a vehicle in both a resting no-idle period and in on-highway operation. It uses an independent power source which can receive power from, but is not limited by, the vehicle's main electrical system. It can achieve variable-speed in a stepless and continuous manner over virtually any range of cooling capacities making it fully compatible with large and small vehicles regardless of operational environment. Furthermore, the subject HVAC system;
(a) provides superior energy to single compressor systems in mid-range operating capacities and high ambient temperatures by two-stage rather than single-stage compression.
(b) permits the use of any type of multi-cell battery configured in voltage strings to supply power at any voltage.
(c) closely manages the charging and discharging of batteries on a cell-by-cell basis to maximize battery life and accurately determine state-of-charge.
(d) uses existing battery charging and storage components in a dual function which allows them to replace a DC-DC converter in a voltage boost function during periods continuous operation.
(e) allows the output voltage of the stored electrical energy to be dynamically changed to perform a load-balancing function with a second source of input power.

Although the description above contains many specific details, these should not be construed as limiting the scope of the embodiments. For example, there are many different types of compressors that can be used such as scroll, reciprocating, rolling piston, swash plate, centrifugal and variations on these designs. Similarly, the type of on-board power sources include direct-drive, gear-driven and belt-drive generators and alternators of many types as well as fuel cells on other less conventional sources of power. In electric or hybrid-electric vehicles, these power sources could also include stored or non-stored energy used to propel the vehicle.

Thus, the scope of the embodiments should be determined by the appended claims and their legal equivalents rather than by the examples given.

What is claimed is:

1. An air conditioning system for use in a mobile vehicle comprising;
a plurality of electrically-powered compressors and,
a refrigerant evaporator in thermal communication with the air of an interior compartment and,
a refrigerant condenser in thermal communication with air outside of the said interior compartment and,
an intelligent control system which operably configures the said plurality of compressors so as provide cooling capacity most optimally matched to the cooling requirement by operating one compressor alone, or a plurality of compressors in parallel or, a plurality of compressors in series, or a combination of compressors in series and in parallel.

2. The air conditioning system of claim 1 in which the said intelligent control system operably configures the said plurality of compressors by electrically opening and closing valves in response to a commanded change in the cooling capacity of the system.

3. The air conditioning system of claim 2 in which the said intelligent control system operably configures the said plurality of compressors by electrically opening and closing valves in response to a commanded change in the cooling capacity of the system and in further response to temperature.

4. The air conditioning system of claim 2 in which the said intelligent control system operably configures the said plurality of compressors by electrically opening and closing valves in response to a commanded change in the cooling capacity of the system and in further response to pressure.

5. The air conditioning system of claim 2 in which the said intelligent control system operably configures the said plurality of compressors by electrically opening and closing valves in response to a commanded change in the cooling capacity of the system and in further response to the power delivery potential of the source of motive power.

6. The air conditioning system of claim 1 in which the said electrically-powered compressors are capable of variable-speed operation.

7. The air conditioning system of claim 1 which further includes a circulating liquid loop to transfer heat from one or more heat producing sources to the said air of an interior compartment.

8. The air conditioning system of claim 7 in which the said heat producing sources include one or more of a fuel-fired heater, an internal combustion engine, solar thermal panels or an electric resistance heater.

9. The air conditioning system of claim 1 which the said plurality of electric compressors are powered at a second voltage and which further includes;
a means to store electric energy comprising;
a plurality of individual cells producing power at a first voltage, said cells being operably connected in series so as to provide output power at the said second voltage and,
a means to provide electric charge energy at a third voltage, said third voltage being a voltage higher than the said first voltage and lower than the said second voltage, and
a means to selectively connect some of the said plurality of individual cells to said electric charge energy means so as to be electrically charged by said third voltage.

10. The air conditioning system of claim 9 in which said third voltage is the same voltage as the vehicle's primary electrical system.

11. The air conditioning system of claim 9 in which the said third voltage is a voltage higher than the vehicle's primary electrical system.

12. The air conditioning system of claim 9 in which the said means to provide electric charge energy is a plurality of means.

13. The air conditioning system of claim 9 in which the said third voltage is a voltage higher than the said second voltage.

14. The air conditioning system of claim 1 in which the said refrigerant evaporator is in thermal communication with a liquid heat transfer loop comprising;
a liquid-air heat exchanger in thermal communication with the air of an interior compartment and,
a circulating pump to circulate a liquid heat transfer solution so as to transfer heat between the said refrigerant evaporator and the said liquid-air heat exchanger.

15. The environmental control system of claim 1 which further includes an intercooling heat exchanger which is operably connected so as to cool the discharge gas of a first compressor before it enters the inlet of a second compressor when the first compressor and the second compressor are operating in series connection.

16. An environmental control system to regulate the temperature of one or more compartments of a mobile vehicle including;
an air conditioning system comprising;
At least one electrically powered compressor and,
an electrical storage battery comprised of a plurality of cells operating individually at a first voltage which are connected in series so as to provide said electrical power at a second voltage and,
a source of electrical power at a third voltage, which is a voltage greater than said first voltage and less than said second voltage and
a dynamic cell charge controller which uses said electrical power at a third voltage to charge said electrical storage battery by selectively and sequentially charging groups of said cells, said groups operating at a combined voltage which is less than said second voltage.

17. The environmental control system of claim 16 which further includes an intelligent control system which varies the speed of the said at least one compressor to produce the required system cooling capacity in the most energy efficient manner.

18. The environmental control system of claim 16 in which the said plurality of cells are connected in a plurality of series sets so as to provide a plurality of output voltages.

19. The environmental control system of claim 16 in which the of said plurality of cells which are connected in series to provide the said electrical power are connected in series by electrically controlled switches.

20. The environmental control system of claim 19 in which the number of the said plurality of cells which are connected in series can be changed in response to an external command to provide a different output voltage.
